(19) United States
(12) Patent Application Publication
(10) Pub. No.: US 2014/0083800 A1
(43) Pub. Date: Mar. 27, 2014

(54) MECHANICAL MOTION SYSTEM FOR ENERGY GENERATION

(71) Applicant: Renato Bastos Ribeiro, Puerto Alegre (BR)

(72) Inventor: Renato Bastos Ribeiro, Puerto Alegre (BR)

(21) Appl. No.: 13/863,280

(22) Filed: Apr. 15, 2013

Related U.S. Application Data
(60) Provisional application No. 61/636,276, filed on Apr. 20, 2012.

(30) Foreign Application Priority Data
Apr. 20, 2012 (BR) 1020120094568

(51) Int. Cl. F03G 3/06

(52) U.S. Cl. CPC F03G 3/06
USPC 185/29

(57) ABSTRACT

Objective—Create a mechanical system to manage the gravitational force exerted on a series of weights; with the ultimate goal of transferring this force to turn a shaft. The system consists of a fixed base and 2 types of mechanical modules. The modules are arranged side-by-side along a crankshaft. One module type consists of rods connected to a crankshaft. Two arms are connected to the fixed structure and to a third arm. All are connected to a central shaft by a connecting rod. A second type of module consists of a support arm for the weight connected to the central axis. The length of the support arm is variable. The arm is held in position by a pin which is pulled at the precise moment; altering the length of the arm. This shifts the center of gravity and drives the crankshaft. The altering of the arms' lengths is synchronized.

### RELATED APPLICATION

This application relates to and claims priority from U.S. Provisional Application 61/636,276 filed Apr. 20, 2012, entitled SYSTEM OF MECHANICAL MOTION FOR POWER GENERATION, still pending, and BR Patent Application 1020120094568 filed Apr. 20, 2012. The contents of these applications are incorporated by reference herein in their entirety.

Continuous and perpetual mechanical motion for energy production exclusively powered by the force or energy of gravity. This application for patent registration is similar to my previous application called “SYSTEM FOR ENERGY PRODUCTION AND EQUIPMENT TO PRODUCE SAID ENERGY” dated Mar. 30, 2012 under number BR 10 2012 007288 2, however, it is different. They are separate and independent applications. In that application, the weight occurs over a rail while in this application the weight is fixed to the end of a bar. In both cases, the arrangement involving the support structure, the crankshaft, the positive and neutral bars are the same. The arc-lock system and placement of the locks that enable the weight to be supported on one or the other bar, positive or neutral at the convenient time is also the same. In both cases the lock can be placed and removed to manage the existing gravity energy on the weight.

### FIELD OF INVENTION

The present invention is in the area of energy production but focused on and with the objective of obtaining this generation by only using the energy of gravity. When we think of exclusively using force of gravity to power the system, and when this force is present at any place and at any time and is constant, we are not referring to perpetual motion that will work forever while the mechanical equipment that makes up the system lasts. This would be the greatest innovation of recent times. It would promote a huge change in the world that will be referred to before and after this invention.

### DESCRIPTION OF RELATED ARTS

For centuries the industrial development and global population growth have been demanding the availability of more energy. Formerly, energy was obtained from firewood and coal, which supplied the energy necessities of the world for a long period of time. For a long time we also had the use of windmills that were replaced by an easier and cheaper means at the time, which was oil and these sources were developed till present. We continue to burn firewood and coal, and this developed into the burning of other types of wastes. When oil became expensive, the use of windmills returned and this also resulted in the use of solar energy. Recently we have the use of fats in general that are transformed into diesel. The continuous increasing need for energy is also forcing the development of other smaller sources of energy. Our field of invention is based on this history of energy, in search of new sources of energy.

In the last centuries thousands of attempts have been made to create a form of using gravity. Major values were invested with this purpose all over the world without obtaining results. For a long time in past centuries the English government offered a large amount as reward for whoever created the then called continuous motion.

### OBJECTION OF THE INVENTION

Therefore, the objective of the present invention is to create a system to produce energy as well as the equipment necessary only using the planet's gravity as source of energy. To achieve the objective above, we developed a conception of different types of motions made up of a crankshaft and mechanical bars that make up assemblies. Furthermore, these assemblies were placed side by side. In this case there is a 45 degrees lag between them. The movements of each assembly are combined and synchronized. Finally, each assembly has a bar on which a fixed weight is supported. This bar is supported on the positive or neutral bars through mobile locks that are placed or removed at the appropriate time.

### DRAWINGS

FIGS. 1-1A shows a perspective view of an equipment completely built to incorporate an illustrative concretization of the system according to the present invention;

FIGS. 2-2A shows a view similar to FIG. 1, where only one of the motion assemblies of the system is highlighted, according to the illustrative concretization of the invention;

FIGS. 3-3A shows a detailed view of the components of one of the motion assemblies of the system according to the illustrative concretization of the present invention;

FIG. 4 shows a view highlighting the dimensions of the component parts of a model of the equipment that is now being built;

FIGS. 5-5A shows a perspective view of a double-equipment that incorporates two systems according to the illustrative concretization of the present invention;

FIGS. 6-6A show a side view of the first of the motion assemblies of the system according to the illustrative concretization of the present invention (angle of the crankshaft ZERO degree, and locks);

FIGS. 7-7A show a side view of the second of the motion assemblies of the system according to the illustrative concretization of the present invention (angle of the crankshaft 45°, and locks);

FIGS. 8-8A show a side view of the second of the motion assemblies of the system according to the illustrative concretization of the present invention (angle of the crankshaft 70°, and locks);

FIGS. 9-9A show a side view of the second of the motion assemblies of the system according to the illustrative concretization of the present invention (angle of the crankshaft 90°, and locks);

FIGS. 10-10A show a side view of the second of the motion assemblies of the system according to the illustrative concretization of the present invention (angle of the crankshaft 149°, and locks);

FIGS. 11-11A show a side view of the second of the motion assemblies of the system according to the illustrative concretization of the present invention (angle of the crankshaft 199°, and locks);

FIGS. 12-12A show a side view of the second of the motion assemblies of the system according to the illustrative concretization of the present invention (angle of the crankshaft 284°, and locks);

FIG. 13 shows a detailed view of one of the mobile lock of the telescopic arm;

FIG. 14 illustrates two crankshafts used in the equipment shown in FIG. 5;

FIG. 15 shows the central shaft and the arms mounted independent of one another;

### LIST OF NUMERICAL REFERENCES USED IN THE DRAWINGS

| Component | Reference number |
|---|---|
| Motion assemblies or arrangements | 1 |
| Crankshaft | 2 |
| Crankshaft Bearing | 3 |
| Support Structure | 4 |
| Connecting Rod | 5 |
| Positive Force Bar | 6 |
| Positive Force Bar | 7 |
| Positive bar fixed lock | 8 |
| Neutral bar fixed lock | 9 |
| Neutral Bar | 11 |
| Central Shaft | 12 |
| Weight Support Bar | 13 |
| Telescopic Arm | 14 |
| Telescopic Arm | 15 |
| Inclination control arm | 16 |
| Weight Rail Support Arm | 17 |
| Weight Arm | 18 |
| Weight | 19 |
| Lock Support Arc | 20 |
| Mobile Lock Drive | 21 |
| Mobile lock spring | 22 |
| Gearing | 23 |
| Machines of the double equipment | M1, M2 |

### DETAILED DESCRIPTION OF THE INVENTION

The presented equipment is built exclusively mechanically, using common material existing in the market. We use beams and angle brackets, cut and rolled steel plates, machined to make up isolated assemblies, placed side by side to work in sequence.

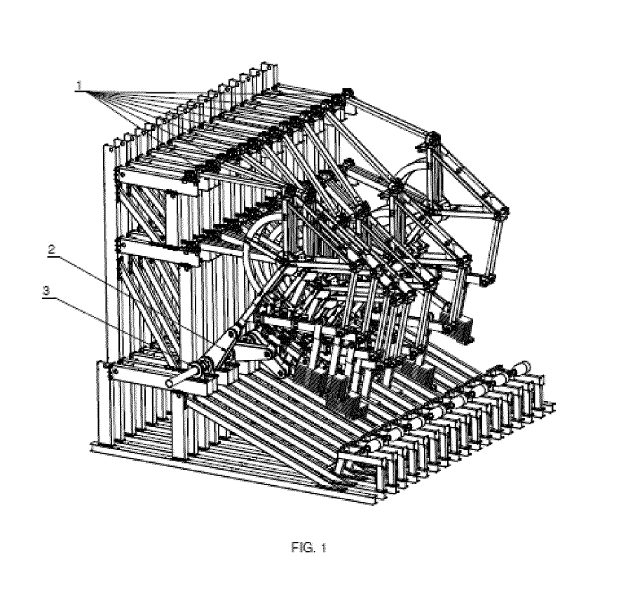

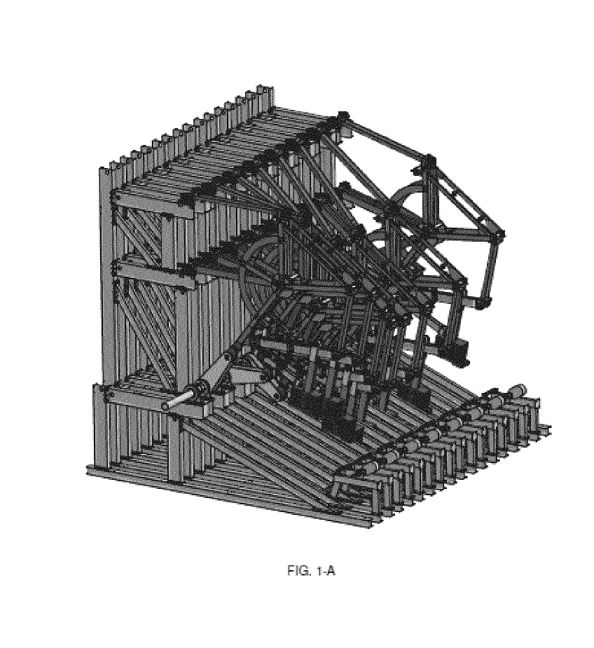

The invention consists in the conception and creation of an assembly where there are bars with positive force and a bar with neutral force. Besides these bars there is another bar over which the weight is placed. This bar is connected to the system made up of an arc where the locks are placed. These locks have the objective of connecting the weight bar to one of the other four bars in the convenient position and also in the suitable time to enable the use of the force of gravity. To achieve this objective, I built a prototype machine where I conducted these force tests. FIG. 1 shows the complete assembly of the force testing equipment, where I could prove the existence of a force other than gravity, and could capture this force and make it available through a torque on the crankshaft. I am now building two new equipment, bigger in size, one in Porto Alegre—Brazil, at avenida Pàtria, 195 and the other in Gilmam, Ill.—United States, at the industrial plant of Incobrasa Ltda. They will be demonstration models and will each produce 15 KW. These equipment do not produce any type of pollution, noise or heat.

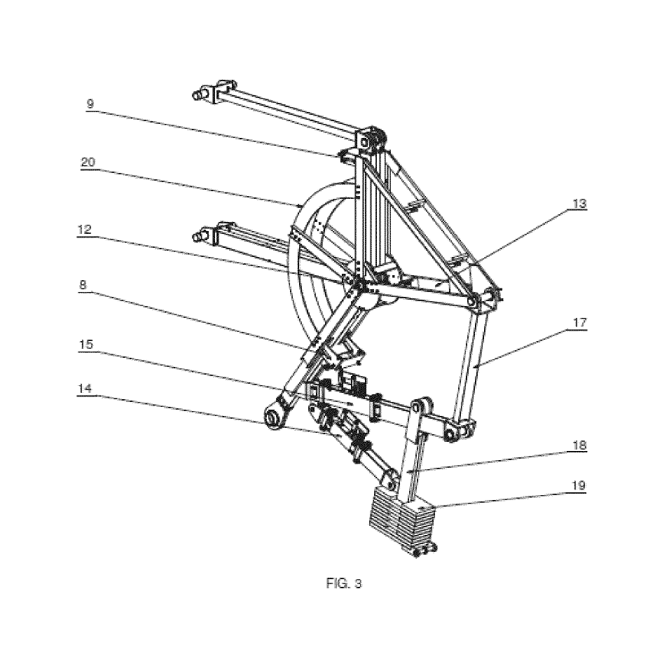

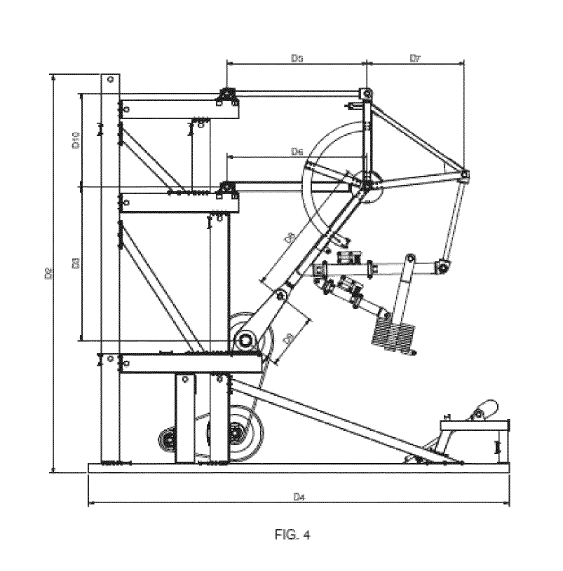

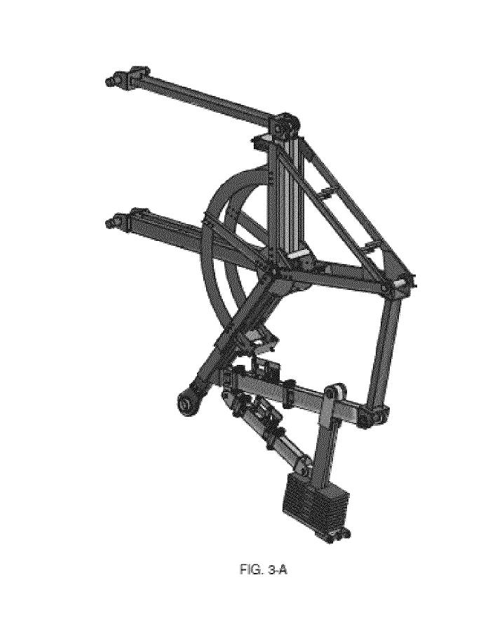

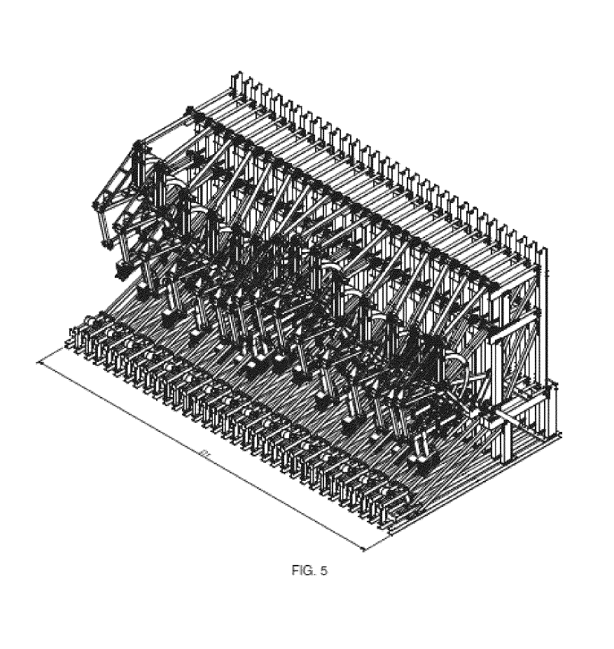

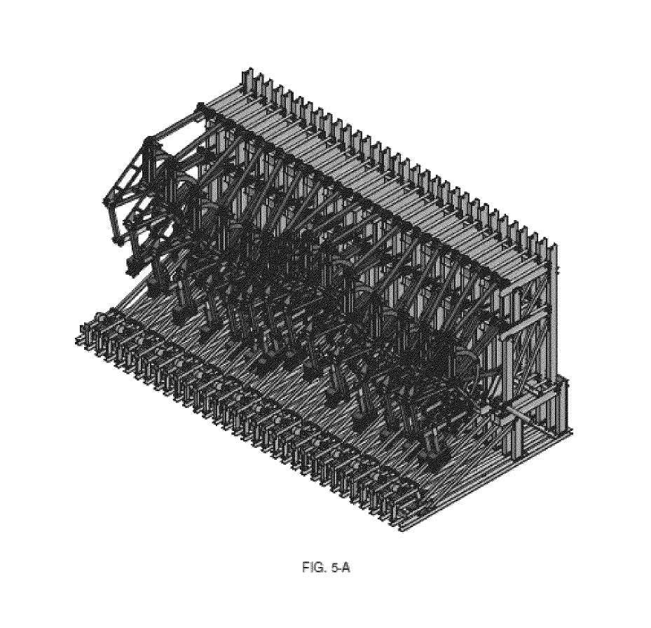

FIGS. 4 and 5 show the dimensions of the components of the equipment according to the illustrative concretization of the present invention. However, it must be understood that these dimensions may be changed to achieve specific yields, according to the necessities of the design to be developed.

The table below shows the dimensions highlighted in the figures.

TABLE 1
Dimensions of the equipment according to the illustrative
concretization of the present invention

| | Dimension | |
|---|---|---|
| Component | reference | Dimension (mm) |
| Support structure 2 (length) | D1 | 17337 |
| Support structure 2 (height) | D2 | 8542 |
| Support structure 2 (crankshaft support/ | D3 | 3298 |
| weight bar support height) | | |
| Support structure 2 (width) | D4 | 9000 |
| Positive bars 4, 5 | D5/D6 | 3000 |
| Weight support bar 3 | D7 | 2100 |
| Positive bar 6 | D8 | 3000 |
| Arm 12 of crankshaft 11 | D9 | 1200 |
| Neutral bar 7 | D10 | 2000 |

The presented equipment and the one being built with the measures indicated in FIGS. 4 and 5 are designed for a weight of 1,000 kg. With this weight, the equipment can produce a value greater than 15 KW of the generator that is being placed and, therefore, the weight that will finally be used will be that necessary to generate 15 KW.

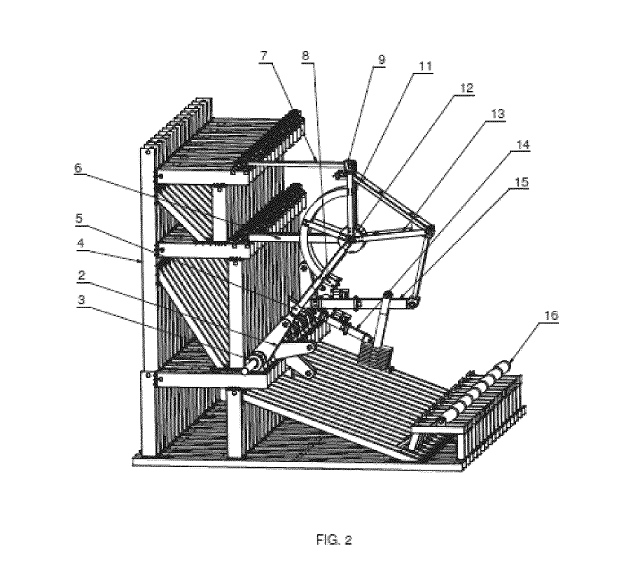

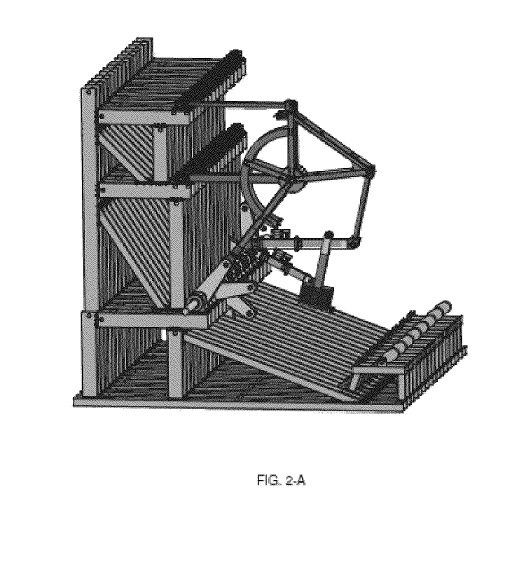

In FIGS. 2 and 3, we presented only the first assembly of bars with their denominations. We also presented the bar that supports the weight, the arc that supports the locks and the crankshaft. Let us then denominate as angle ZERO the initial motion point to be presented, and that shows the arm of the crankshaft aligned with the positive blue bar in FIGS. 2 and 3. From this point, the motion will be clockwise. From now on we can call the bars by the numbers indicated in the figures, as well as weight support bar and crankshaft arm. We can see in the figure that bars 6 and 7 are connected to a fixed point of the structure and also to bar 11. They are mounted in such a way that bar 11 always remains in the vertical position during the entire movement. This bar 11 is connected to the bar 5 that will transmit the force to the crankshaft arm. We can also see that the weight support bar is connected in a fixed manner to the arc-locks, as seen in FIGS. 2 and 3. This weight support bar and the arc-locks are mounted on the same shaft that are mounted to bars 11, 5, 6 and 7, but are not fixed to any of these bars. The weight support bar, through the arc-locks, only supports itself on one of the other bars as the locks fixed to the arc-locks are placed or removed, as convenient in order to obtain the desired results.

The weight support bar and arc-locks make up a secondary arrangement together with the telescopic support arm, 17, which is also connected to the arm where the fixed lock is 8. This upper telescopic arm 15 supports the lower telescopic arm 14 and the weight 19 and the weight arm 18.

The force of gravity exerted on the secondary arrangement that includes the weight and the two telescopic arms is transferred to the assembly through the central shaft. This shaft, depending on where the locks are supporting, if they are on the positive or neutral arms and when, transfer more or less force to bar 5. This in turn transfers the force to the crankshaft arm that is transferred to the crankshaft where the torque is applied.

The arrangement shown in FIGS. 1, 2 and 3 involving a support structure, a crankshaft, an assembly of interconnected arms, on the support structure and on the crankshaft and also a secondary arrangement consisting of weight support bar, the two telescopic arms and the weight was specially designed and created with the objective and purpose of making it possible to work and manage the effects of the force of gravity that exists on the entire assembly and especially on the weight. By choosing the radius of the crankshaft, the length of the arms and the angles, I am mounting a mechanical system that allows me to manage how the effects of gravity occur. These primary and secondary arrangements then have the specific function of making it possible to choose how the force of gravity will be transmitted part by part to the crankshaft. It also allows me to choose through the placement or removal of locks where I support the weight support bar and the weight itself, which can be on positive bar 6, positive bar 5 or on the neutral bar 11. The function of removing and placing the locks on the convenient bar and at the convenient time is of extreme importance to manage the force of gravity. Also, when I choose at which crankshaft angles the weight support bar is supported, that is, how long they remain supported on one or another bar, I am managing the force of gravity existing on the entire assembly and especially on the weight.

A fundamental part of the invention is the primary arrangement and secondary arrangement that were designed and created to enable handling the force of gravity existing on the weight support bar and the weight itself. The change in proportion of dimensions between each part of the arrangement can improve the yield of the invention, but the important thing is the formation of the arrangement that creates the possibility of choosing how to transfer the force of gravity that exists on the weight support arm and on the weight to the crankshaft

Another fundamental part is the function of the locks that can be placed and removed to choose the exact moment and period when they should be supported on one or another positive or neutral bar.

Shown below is the influence of the forces of gravity when the weight bar is supported on bars 5, 6 or 11.

1—When the secondary arrangement that includes the weight being supported on neutral bar 11 through the lock that is placed on the support arc of the locks, the force of gravity exerted on the weight will always be the same and will have the same value anywhere on the support bar where the weight is hanged from. Therefore, the value of the force of gravity that the weight support bar transfers to the central shaft is exactly the same. Hence, everything occurs as if the weight was hanging from the central shaft, even if it is really hanging from the central shaft or from the tip of the weight support bar. At any point of the assembly motion, that is, turning the crankshaft 360 degrees, the weight support bar will remain in the horizontal position. This is because the neutral bar 11 always remains in the vertical position. When connected to this bar, the weight support bar consequently remains in the same position. With all the eight weight bars supported on the neutral bar 11, the equipment will be balanced. It moves freely with any impulse and stops at any point.

2—When the secondary arrangement that includes the weight is supported on positive bar 6 through the lock that is placed in the arc-lock support, the force of gravity exerted on the bar and weight that is transferred to the central shaft will increase, that is, an additional force of proportional value between the length of the weight support bar and the distance between central shaft and the point on the weight support bar where the center of gravity of the secondary arrangement is located. Therefore, on the equipment shown in FIGS. 1 and 2, the length of positive bar 6 is 3 meters. During the crankshaft motion, the center of gravity of the secondary arrangement will move and therefore the additional force will also vary. As the center of gravity of the secondary arrangement moves to the right, increasing the distance between the central shaft and the point of the center of gravity on the weight support bar, the additional force will increase in the same proportion. Whenever the weight bar remains supported on the positive bar 6, it will incline in the same angle and direction of the positive bar 6. When the assembly leaves angle zero of the crankshaft in the clockwise direction, the weight support bar inclines until the assembly reaches the lowest point. From the lowest point to the highest point, the weight support bar will incline in the anticlockwise direction and when the crankshaft reaches angle zero the weight support bar will once more be in the initial position. It is worth emphasizing that the force of gravity existing on the central shaft and its addition is transmitted to the crankshaft through the positive bar 5 and depending on the angle of the crankshaft arm, the force will be proportional to the this angle. Therefore, there is a low and high force variation for each position existing between the crankshaft arm and the positive bar 5.

3—When the secondary arrangement that includes the weight is supported on positive bar 5 (connecting rod), we have a very complex and complicated situation compared to the support on neutral bar 11 or positive bar 6. Regarding the force of gravity existing on the secondary arrangement that includes the weight, this force will also have an increase or an additional force when this force is transferred to the central shaft, in the same way it occurs and has already been described when the support is on the positive bar 6. That is, on both positive bars 6 and 5, the force of gravity transmitted to the central shaft is proportional to the length as already indicated in number 2. However, when the force of the central shaft is transmitted to the crankshaft arm through positive bar 5, a very complex and complicated formation of forces occurs, as already mentioned.

Starting from angle zero of the crankshaft in the clockwise direction, there will be either a negative or positive force as the crankshaft arm moves. During this initial motion, the weight support bar will incline in the same direction of the positive bar 5. After a certain period that the crankshaft moves, the positive bar 5 inverts its movement of inclination and consequently the weight support bar also inverts its movement of inclination. Furthermore, the resulting forces of the inclination of the positive bar 5 in relation to the crankshaft arm changes in a very complicated manner.

### DETAILED OPERATION OF THE INVENTION

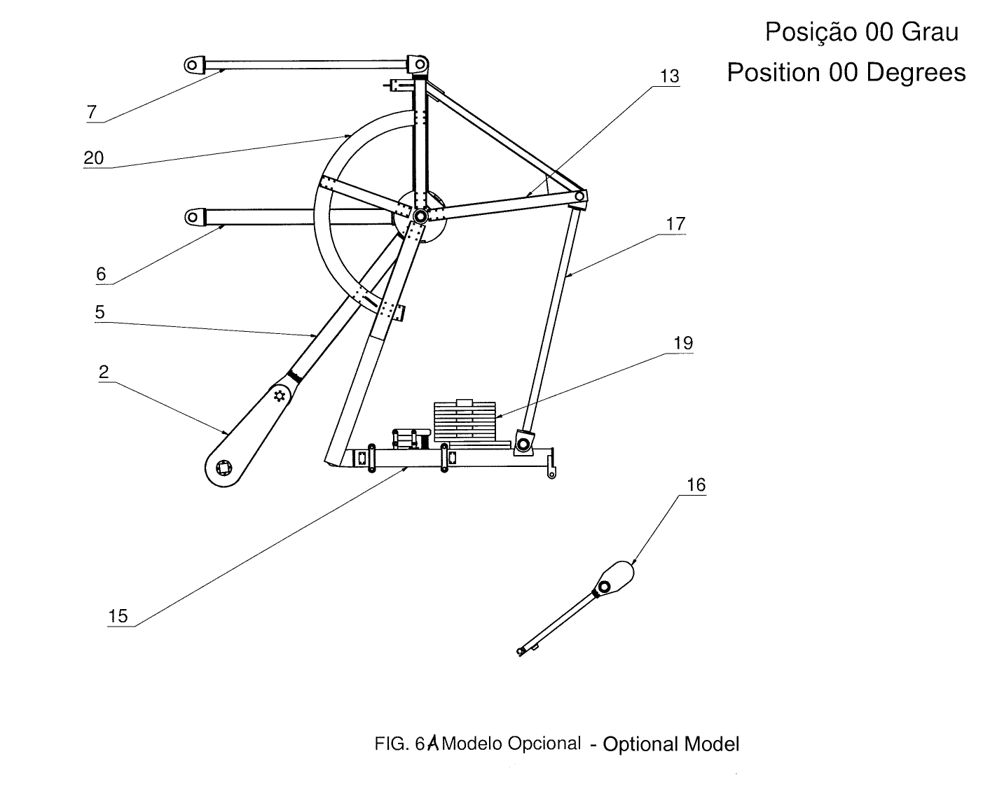

FIG. 6 shows a crankshaft arm aligned with the positive bar 5 (connecting rod), and this point will be denominated angle ZERO of the crankshaft where the movement cycle begins. Also at this point, the weight support bar that controls the entire weight support is inclined 7° up. The secondary arrangement that includes the weight is supported on neutral bar 11, where the fixed lock is supported on bar 11. Also, this arrangement is also supported on the positive bar 5 through the fixed lock 8. The entire secondary arrangement that includes the weight and telescopic arms 14 and 15 are built in a way that the center of gravity of this arrangement is at a previously planned point and at this crankshaft angle, the center of gravity is in the maximum position to the left when projected towards the weight support bar. During the first moment of motion, the lock supported on neutral bar 11 moves away from this bar and the entire secondary arrangement will then be supported on the positive bar 5. Also, the center of gravity of the secondary arrangement will move to the right, increasing the distance of its projection on the weight support bar with the central shaft.

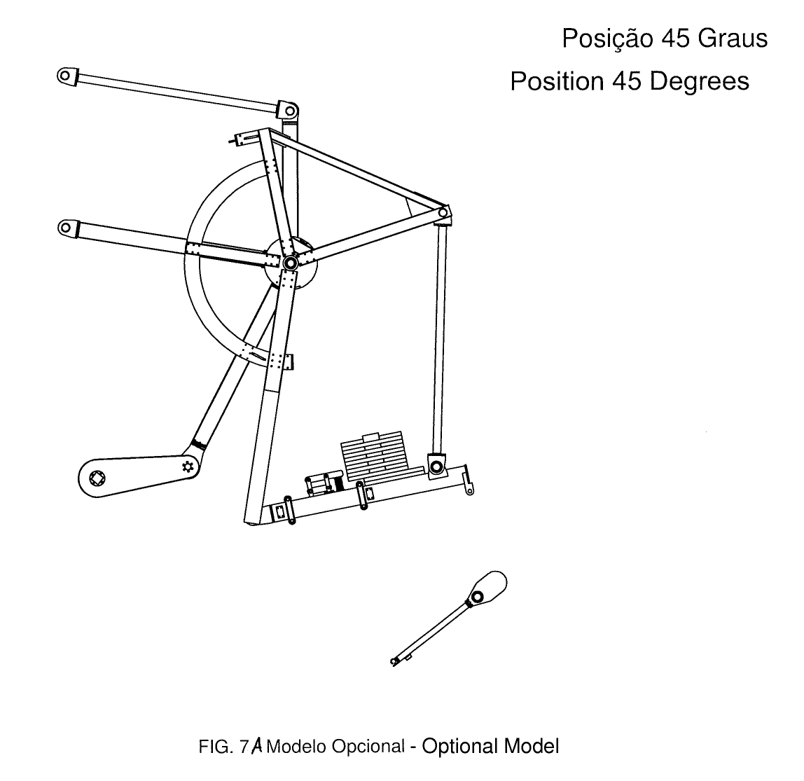

FIG. 7 shows the crankshaft arm in the 45 degrees position. We emphasize that in this position, another arms is in the zero degree position, and the next arms are in the 90 degrees position, 135 degrees position and so on. In the 45 degrees position, the lock supported on neutral bar 11 is moving away and the angle of the weight support bar that controls the entire secondary arrangement is inclining upwards. The center of gravity is moving even more to the right.

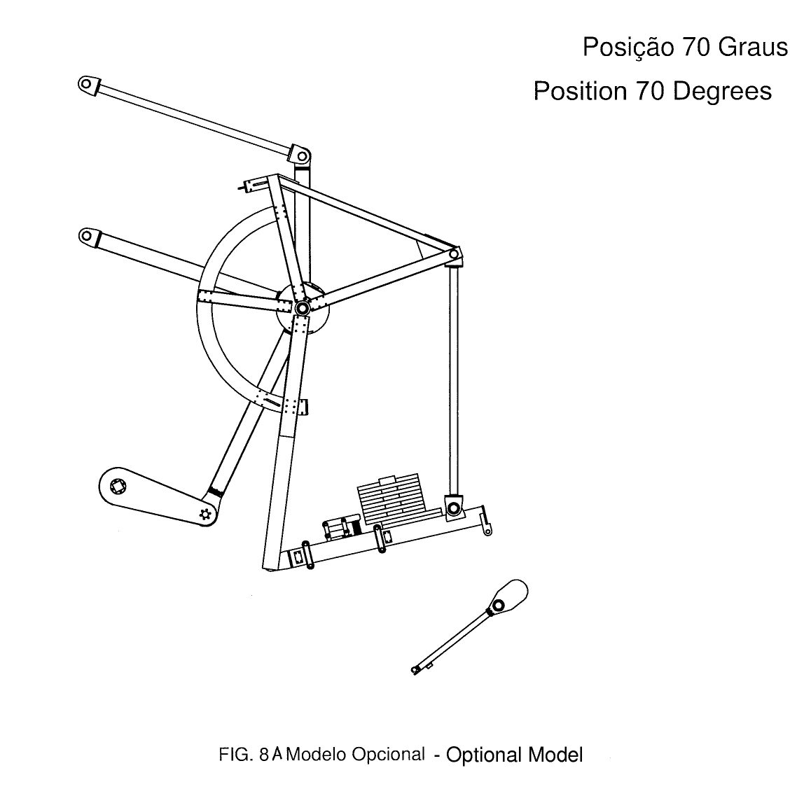

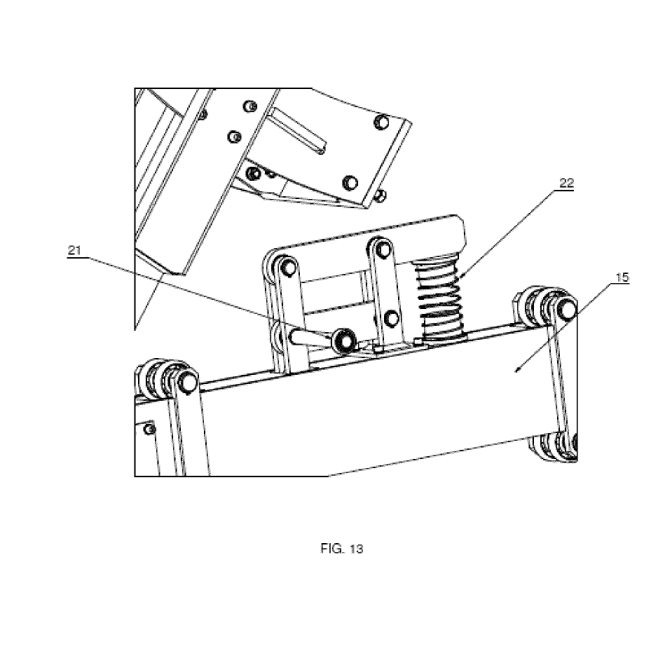

FIG. 8 shows the crankshaft arm in the 70 degrees position. In this position, the lock of neutral bar 11 is at the maximum distancing point. The weight support bar 13 has its inclination upwards at the maximum point and the center of gravity of the secondary arrangement controlled by the weight support arm, which we repeat, involves the weight and telescopic arms, is at the maximum point to the right. At this point, the existing locks on the telescopic arms will unlock as shown in FIG. 13, the roller 21 will touch a fixed point of the structure, which will cause the lock to lift up, enabling both telescopic arms to increase in length. Therefore, when the crankshaft arm moves to 149 degrees, the secondary arrangement with the weight and telescopic arms will keep its center of gravity with its projection on the weight support bar at the maximum point to the right.

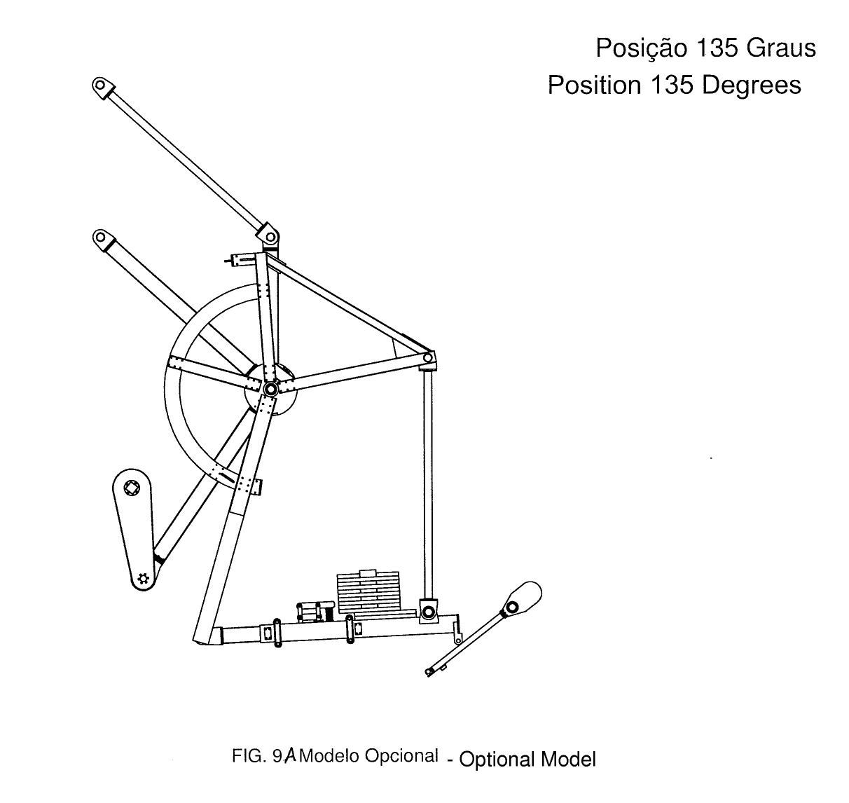

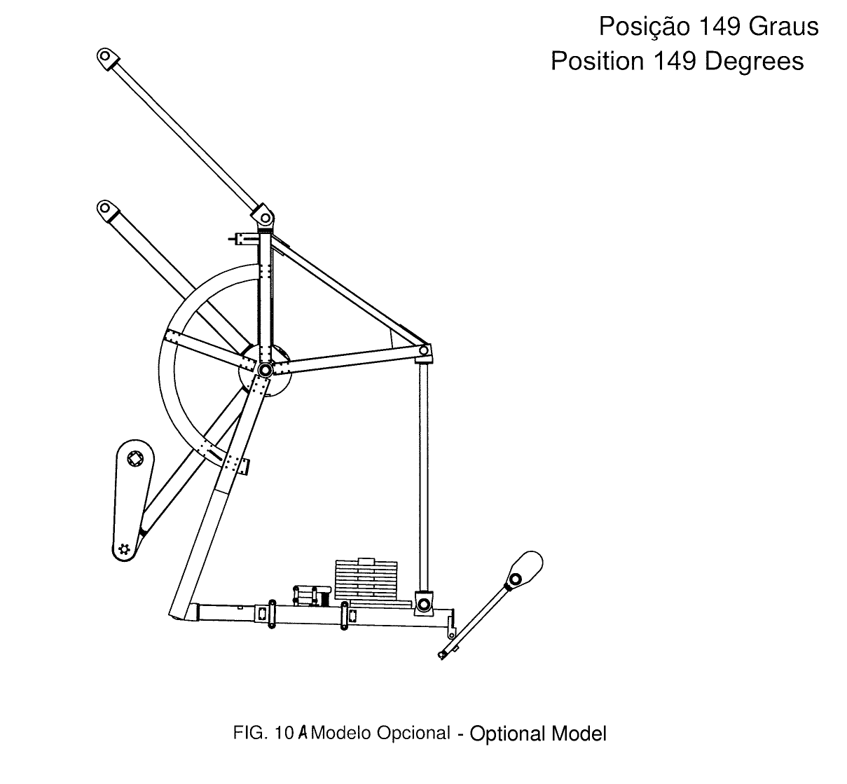

FIGS. 9 and 10 show the crankshaft arm at 135 degrees and 149 degrees and it can be observed that the length of the telescopic arms increased and with this the center of gravity of the secondary arrangement remained at the maximum point to the right. The lock of neutral bar 11 went back to resting on neutral bar 11, and the weight support bar returned to its initial position of 7 degrees upwards. During the movement from 70 degrees to 149 degrees, while the center of gravity of the secondary arrangement with weight and telescopic arms always remained in the maximum position to the right and this created an additional force on the positive bar 5 (connecting rod). Therefore, the distancing of the center of gravity of the secondary arrangement to the right caused the force of gravity existing on the secondary arrangement to reach the central shaft and the crankshaft arm with an additional value that will cause the permanent rotation of the crankshaft.

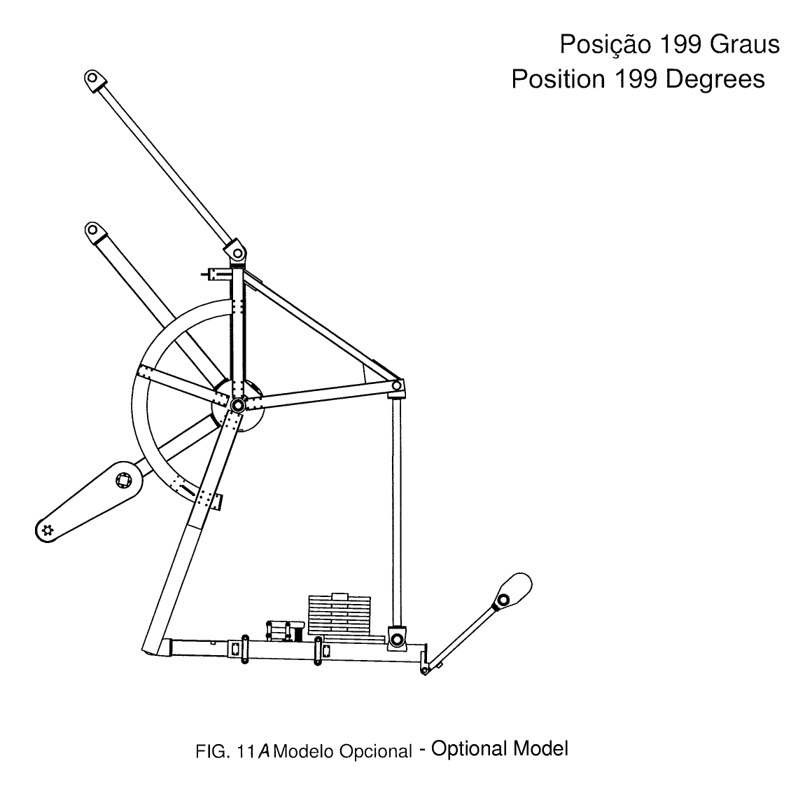

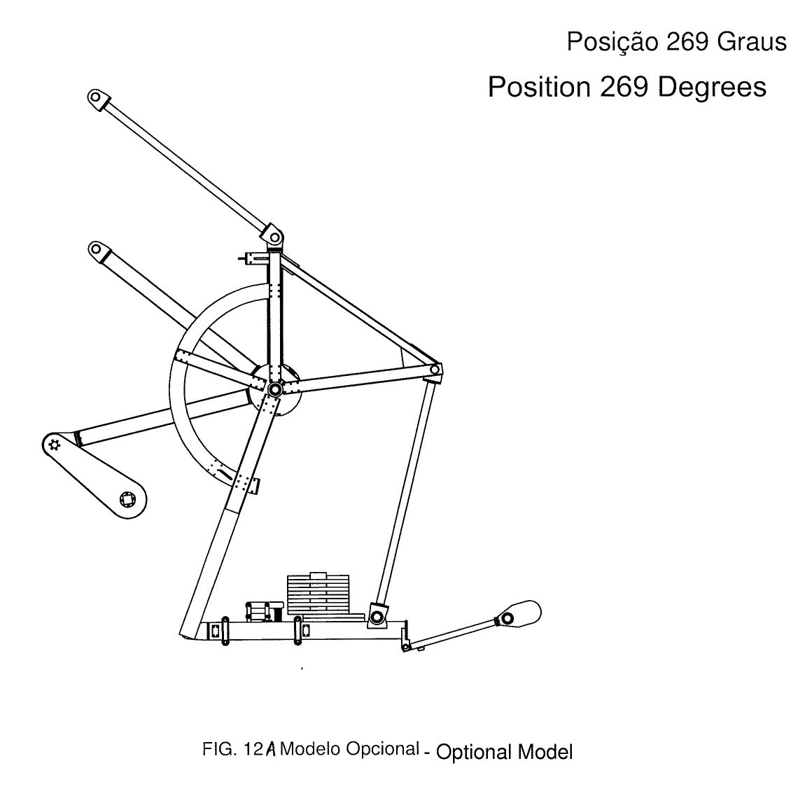

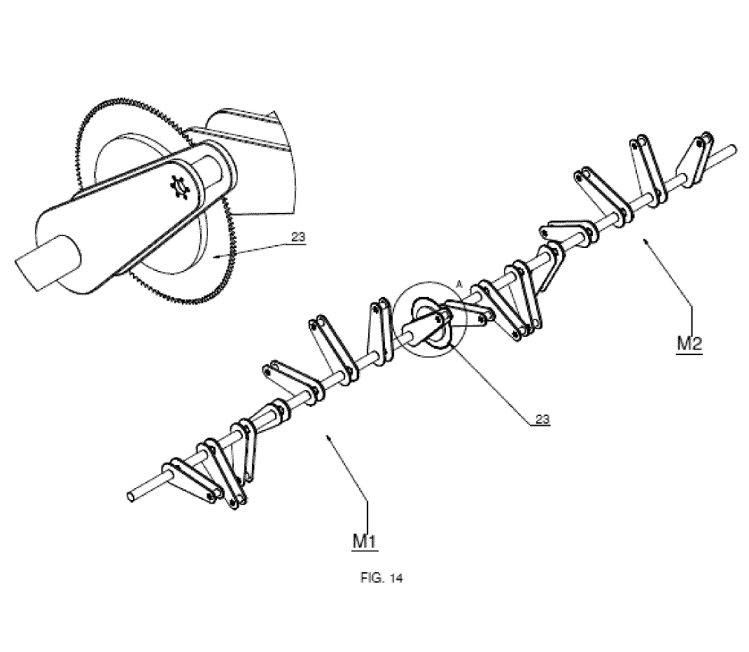

FIG. 11 shows the crankshaft arm at 199 degrees when the weight automatically connects to the inclination control arm 16, which will cause the movement of the telescopic bars to the left during the movement from 199 degrees to 284 degrees, and cause the bars to reach 284 degrees, the locks of both telescopic arms will lock automatically, pushed by the spring 22, and the entire arrangement will be in the initial position. During this movement, the entire secondary arrangement will remain supported on the lock of neutral bar 11 and will remain supported on this lock until the 360 degrees or zero degree of the new cycle. Whenever the first arm of the crankshaft leaves the zero degree position, the arms at 45, 90 and 135 degrees will be operating with the neutral bar lock at a distance and the other five crankshaft arms will be supported on the lock of neutral bar 11. Therefore, the arm that left the zero degree and the arms at 45, 90 and 135 degrees will be generating an additional force on the central shaft that will transmit it to the crankshaft in comparison with the force that will exist if these arms were supported on the neutral bar. The force of gravity existing on the secondary arrangement with weigh and telescopic arms will multiply or increase as a result of the movement of the center of gravity on the entire secondary arrangement. We repeat that this increase in force will generate a permanent and perpetual motion that will occur in a planned, organized and synchronized manner in the movements of the primary and secondary arrangement and all will be transmitted to the crankshaft. At every 45 degrees cycle, the force that reaches the crankshaft is variable during this 45 degrees cycle. To coordinate or stabilize this additional force, I planned to work with two equipment connected by the crankshaft but with 22.5 degrees lag between them. At the connection point, the gear 23 can be observed in FIG. 14, which will transmit the additional force to a normal electric generator. FIG. 5 shows a set of two equipment.

FIG. 13 shows a detailed drawing of the lock of the telescopic arm 15, which is the same as the lock of the telescopic arm 14.

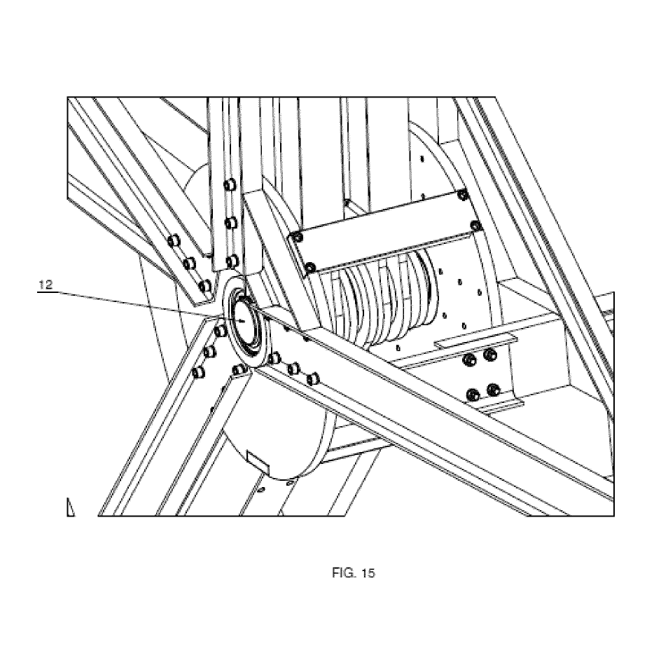

FIG. 15 shows the detailed central shaft marked by the number 12 and also shows that the secondary arrangement is completely independent of the other bars and is supported on the ends of the central shaft 12. Besides this support on the ends of the central shaft, this secondary arrangement has a second support on one of the other bars, as planned.

FIG. 14 shows the crankshaft of equipment 1 and equipment 2 connected and the gearing placed in this connection that will transmit the force to a normal generator, according to FIG. 4.

The industrial application of this equipment is broad and unlimited. The entire world seeks a source of producing energy without pollutants or heat that can destroy the atmosphere. A few days ago, the US president mentioned in his inaugural speech that the US would have the main goal of producing energy with renewable resources. He still has no idea that we will be able to produce energy with resources eternally available at any quantity, at any place or time, without noise, pollution or heat. This invention will certainly promote an industrial and world revolution in the coming decades.

1. Mechanical motion system for energy generation characterized by being exclusively powered by the force or energy of gravity, consisting of a primary arrangement and a secondary arrangement. Both were designed and created with the specific function of enabling the handling of the force of gravity existing on the weight (19), FIG. 3. The weight is part of the secondary arrangement that consists of a weight support bar (13), the arc-locks (20), the support arm of the telescopic arms (17), the telescopic arms (14) and (15) and the weight (19). This secondary arrangement makes up an assembly that works as a single weight supported at the end of the central shaft (12) and on one of the support bars of the main assembly. Its function is to enable the displacement of the center of gravity of the entire assembly and transmit to the primary arrangement the force of gravity to one of the positive bars (5), (6), (7) or neutral bar (11). The primary arrangement consists of mechanical assemblies mounted side by side, consisting of the crankshaft (2), positive bars (6), (7) and neutral bar (11) and the connecting rod (5) that is also a positive bar. The bars are connected to a central shaft (12). Both arrangements can be seen in FIG. 2. The design was created so that the weight formed by the secondary arrangement could be transferred to one of the primary arrangement bars that leads to the central shaft (12), and this in turn, through the connecting rod (5), leads to the crankshaft arm (2) and reaches the crankshaft arm where the torque is available.

2. Mechanical motion system for energy generation according to claim 1, characterized by side by side mounting of the entire assembly consisting of primary and secondary arrangements as shown in FIG. 1. We can choose the number of crankshaft arms. These arms receive an impulse from the positive bar (5) (connecting rode), which is connected to the crankshaft arm (2) and to the central shaft (12). The positive bar (6) and neutral bar (11) are also connected to the central shaft. The positive bar (6) is connected to the structure (4). The neutral bar (11) is connected to another positive bar (7), parallel to the positive bar (6) and is also connected to the structure. The secondary arrangement has the arc-locks (20), and over it can be placed locks that support the secondary arrangement on any of the bars of the primary arrangement. The primary arrangement was also designed so that the neutral bar (11) remained in the vertical position during the entire motion.

3. Mechanical motion system for energy generation according to claim 1 or 2, characterized by the lock system that exists over the arc-locks (20) and over the telescopic arms (14) and (15). These locks can be placed on any of the bars of the primary arrangement. In the present case represented by the equipment we are building, it can be observed that we chose to place the locks on the neutral bar (9) and on the positive bar (8) as shown in FIG. 2. Furthermore, we placed a lock on each of the telescopic arms as shown in FIGS. 3 and 13. All this is characterized by the design and creation of the arrangements that enable the choice of which of the locks to use, at what time of the 360 degrees movement of the crankshaft and for how long each of the locks remain in operation. The locks on the arc-locks will determine the path of the force of gravity within the system, starting from the secondary arrangement to the crankshaft. The locks of the telescopic arms will enable the displacement of the center of gravity of the entire secondary arrangement at the convenient time and period.

4. Mechanical motion system for energy generation according to claim 1 or 2, characterized by the fact that the aforementioned arrangements have the possibility of being built by managing the dimensions of the structures and arrangements, the length of the bars, the dimension of the crankshaft and the number of arms as well as the angles formed during mounting of the arrangements. Therefore, using the same design and creation of the system we can build any equipment size, choose the proportions of greater yield and design the system with the resistance for the weight contained in the secondary arrangement.

5. Mechanical motion system for energy generation according to claim 1 or 2, characterized especially for the function of two telescopic arms that make up the secondary arrangement and that are connected to the positive bar (5) through the lock on the same positive bar (5) placed on the arc-locks. The function of these telescopic arms is to displace the center of gravity existing in the secondary arrangement, as the locks are handled in the convenient time and period.

6. Mechanical motion system for energy generation according to claim 3, characterized by the fact that the aforementioned arrangements have the possibility of being built by managing the dimensions of the structures and arrangements, the length of the bars, the dimension of the crankshaft and the number of arms as well as the angles formed during mounting of the arrangements. Therefore, using the same design and creation of the system we can build any equipment size, choose the proportions of greater yield and design the system with the resistance for the weight contained in the secondary arrangement.

7. Mechanical motion system for energy generation according to claim 3, characterized especially for the function of two telescopic arms that make up the secondary arrangement and that are connected to the positive bar (5) through the lock on the same positive bar (5) placed on the arc-locks. The function of these telescopic arms is to displace the center of gravity existing in the secondary arrangement, as the locks are handled in the convenient time and period.

8. Mechanical motion system for energy generation according to claim 4, characterized especially for the function of two telescopic arms that make up the secondary arrangement and that are connected to the positive bar (5) through the lock on the same positive bar (5) placed on the arc-locks. The function of these telescopic arms is to displace the center of gravity existing in the secondary arrangement, as the locks are handled in the convenient time and period.
